(19) United States
(12) Patent Application Publication
(10) Pub. No.: US 2012/0330513 A1
(43) Pub. Date: Dec. 27, 2012

(54) AIR DAM ACTUATION SYSTEM

(75) Inventors: Scott P. Charnesky, Birmingham, MI (US); Gregory J. Fadler, Commerce Township, MI (US); David J. Guidos, Brighton, MI (US)

(73) Assignee: GM GLOBAL TECHNOLOGY OPERATIONS LLC., Detroit, MI (US)

(21) Appl. No.: 13/168,401

(22) Filed: Jun. 24, 2011

(51) Int. Cl. G06F 17/00

(52) U.S. Cl. 701/48; 701/49

(57) ABSTRACT

A system for air dam actuation of a vehicle is provided having an object sensor, an air dam, an actuation mechanism, and a control module. The object sensor is for tracking external objects located in front of the vehicle. The air dam has a deployed position and a non-deployed position. The actuation mechanism is connected to the air dam, and actuates the air dam between the deployed and the non-deployed position. The control module is in communication with the object sensor and the actuation mechanism. The control module includes logic for monitoring the object sensor for a set of object data. The set of object data is data indicating if an external object is located in front of the vehicle.

### FIELD OF THE INVENTION

Exemplary embodiments of the invention relate to a system for actuating an air dam of a vehicle and, more particularly, to a system for actuating an air dam of a vehicle using an object sensor.

### BACKGROUND

Many motor vehicles are equipped with an air dam located underneath the front of the vehicle. Air dams improve the handling, control, and fuel economy of a vehicle. Air dams also conceal the undercarriage components of the vehicle and direct airflow to the radiator for increased cooling. However, the aerodynamic improvement of the vehicle due to the air dam typically varies with the speed of the vehicle. Moreover, air dams may become damaged by obstructions located on the road, especially if the vehicle has a low ground clearance. For example, if a driver runs into a curb or up an inclined driveway, the air dam may become damaged or even tear off. Without an air dam, less air will be directed into the engine, which may lead to decreased horsepower or to the engine overheating.

One approach to minimize damage to the air dam involves the air dam being moveably mounted to the front end of the vehicle in a deployed position and a non-deployed position. At lower vehicle speeds, which are typically below about 56 kph, the air dam remains in the non-deployed position and is substantially above the road surface. At higher vehicle speeds, which are typically above 56 kph, the air dam is lowered into the deployed position and is in proximity with the roadway. However, the system can not determine if there are objects in the way of the air dam that could create damage when the air dam is in the deployed position. Moreover, a moveable air dam tends to be located in a significantly lower location underneath the vehicle when compared to a static air dam that does not actuate. This makes a moveable air dam especially susceptible to damage by obstructions on the road.

In an alternative approach, a separate detection system is provided in the vehicle for determining the presence of objects that may impact the air dam. The sensing system alerts the driver that further forward movement of the vehicle will cause damage to the air dam. However, one drawback to this approach is that the sensing system can include complex and costly circuitry. Therefore, there exists a need for a cost-effective approach for minimizing damage to the air dam of a vehicle during driving.

### SUMMARY OF THE INVENTION

In one exemplary embodiment of the invention, a system for air dam actuation of a vehicle is provided having an object sensor, an air dam, an actuation mechanism, and a control module. The object sensor is for tracking external objects located in front of the vehicle. The air dam has a deployed position and a non-deployed position. The actuation mechanism is connected to the air dam, and actuates the air dam between the deployed and the non-deployed position. The control module is in communication with the object sensor and the actuation mechanism. The control module includes logic for monitoring the object sensor for a set of object data. The set of object data is data indicating if an external object is located in front of the vehicle. The control module includes logic for determining if the data indicates that the external object located in front of the vehicle has the potential to impact the air dam. The control module includes logic for determining a time to collision (“TTC”) between the air dam and the external object located in front of the vehicle if the external object has the potential to impact the air dam. The TTC is based on at least the vehicle speed and the set of object data. The control module includes logic for sending a signal to the actuating mechanism for actuating the air dam from the deployed position into the non-deployed position if the TTC is below a threshold time value.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic illustration of a vehicle including a system for actuating an air dam;

FIG. 2 is an illustration of the vehicle shown in FIG. 1 and an external object; and

FIG. 3 is an illustration of an exemplary air dam and air dam actuation mechanism.

### DESCRIPTION OF THE EMBODIMENTS

The following description is merely exemplary in nature and is not intended to limit the present disclosure, its application or uses. As used herein the terms module and sub-module refer to an application specific integrated circuit (ASIC), an electronic circuit, a processor (shared, dedicated, or group) and memory that executes one or more software or firmware programs, a combinational logic circuit, and/or other suitable components that provide the described functionality. It should be understood that throughout the drawings, corresponding reference numerals indicate like or corresponding parts and features.

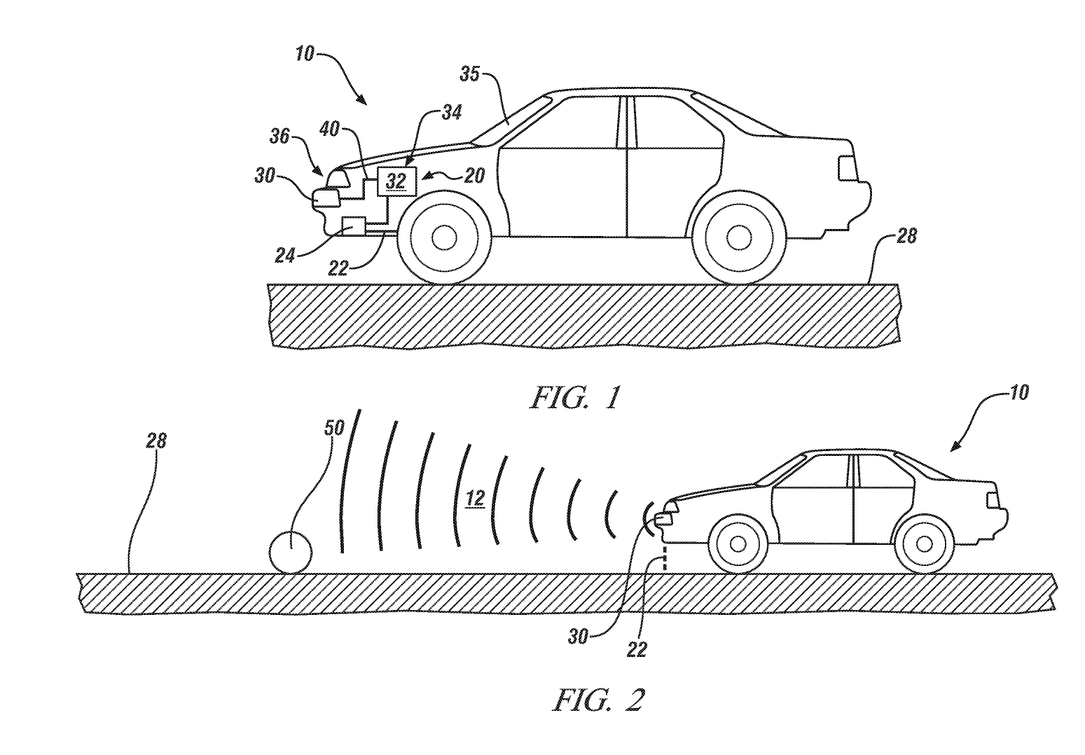

In accordance with an exemplary embodiment of the invention FIGS. 1-2 illustrate a vehicle indicated by reference number 10. The vehicle 10 includes an air dam actuation system 20 having an air dam 22, an air dam actuation mechanism 24, an object sensor 30, and a control module 32. The air dam actuation system 20 is employed to actuate the air dam 22 between a deployed position (shown in phantom in FIG. 2) and a non-deployed position (shown in FIG. 1), where the default position of the air dam 22 is typically in the non-deployed position. In the deployed position, the air dam 22 is lowered to re-direct air flow to enhance vehicle control and engine cooling. In the non-deployed position, the air dam 22 is located substantially above a road surface 28 and does not generally re-direct airflow. The air dam 22 is typically raised into the non-deployed position if the vehicle is being driven at lower speeds, or if an obstruction that could potentially damage the air dam 22 is detected on the road surface 28 by the air dam actuation system 20.

The object sensor 30 is located in a front portion 36 of the vehicle 10, behind a grille panel (not shown) or windshield 35. The object sensor 30 is any type of device used for detecting the distance 12 between the vehicle 10 and an externally located object, and may include technologies such as, for example, long range radar, short range radar, a camera, or light detection and ranging (“LIDAR”) optical remote sensing technology. Specifically, the object sensor 30 is employed for determining the distance 12 between the vehicle 10 and an object or obstruction located on the road surface 28. The object sensor 30 is in communication with the control module 32 through a data connection 40. The object sensor 30 sends data signals to the control module 32 indicating the distance 12 between the vehicle 10 and an object located on the road surface 28.

In one embodiment, the object sensor 30 and the control module 32 are part of an adaptive cruise control (“ACC”) system 34. The ACC system 34 is typically employed to maintain vehicle set speed, detect other vehicles located in front of the vehicle 10 during driving, and adjust the vehicle speed based on the location and distance of objects located in front of the vehicle 10. The control module 32 includes logic for determining if the vehicle 10 is following too closely behind another vehicle based on the data received from the object sensor 30. In another embodiment, the object sensor 30 and the control module 32 are part of a collision mitigation braking system (“CMB”). The control module 32 includes logic for determining the likelihood of a collision based on driving conditions and the distance between other vehicles located in front of the vehicle 10. If a potential collision is identified, a warning may be triggered to alert a driver. The CMB system may also initiate braking by a brake system (not shown) to reduce vehicle speed. Specifically, the control module 32 includes logic for initiating braking by a brake system if it is determined that a collision between the vehicle 10 and another vehicle may occur.

The air dam actuation system 20 also may employ the object sensor 30 of the ACC system 34 or the CMB system to determine if there are objects or obstructions on the road way 28 that could potentially create damage to the air dam 22 when the air dam 22 is in the deployed position. In one embodiment, the control module 32 includes logic for actuating the air dam 22 between the deployed position and the non-deployed position. Although the control module 32 is shown, it is understood that other control modules located in the vehicle 10 could also determine the position of the air dam 22 as well. It should also be noted that while an ACC and a CMB system are discussed, it is understood that the object sensor 30 and the control module 32 could be components that are dedicated to determining the position of and actuating the air dam 22 as well.

The position of the air dam 22 between the deployed and the non-deployed position depends on vehicle speed as well as if an obstruction, such as the external object 50, is detected on the road surface 28 by the object sensor 30. The control module 32 includes logic for monitoring the object sensor 30 for data indicating the presence of the external object 50 in front of the vehicle 10. Specifically, the control module 32 includes logic for determining if the external object 50 located in front of the vehicle 10 could potentially create damage to the air dam 22 in the event of a collision between the air dam 22 and the external object 50. For example, if the object sensor 30 sends data to the control module 32 indicating that the external object 50 located in front of the vehicle 10 would not potentially impact the air dam 22, then the control module 32 disregards the data indicating the external object 50. For example, if the external object 50 was another vehicle, then the control module 32 would disregard the external object 50 when determining whether to actuate the air dam 22 into the non-deployed position. In one embodiment, if the control module 32 receives a data signal from the object sensor 30 indicating that the external object 50 located in front of the vehicle 10 is stationary (i.e., a piece of wood or a raised surface on the roadway), this is generally an indication that the external object 50 would potentially impact the air dam 22, and the air dam 22 should be actuated in the non-deployed position. In contrast, the control module 32 typically disregards the object data that indicated the external object 50 is stationary when determining whether to adjust vehicle speed for ACC or CMB control.

The control module 32 also includes logic for determining a time-to-collision (“TTC”) between the external object 50 located in front of the vehicle 10 and the air dam 22. The TTC is based on at least the speed of the vehicle 10, the distance 12 between the vehicle 10 and the external object 50 located in front of the vehicle 10, and the time need to actuate the air dam 22 from the deployed position to the non-deployed position. If the TTC is below a threshold time value, then the control module 32 includes logic for sending a data signal to the air dam actuation mechanism 24 for actuating the air dam 22 into the non-deployed position. In one embodiment, the threshold time value for the TTC ranges from between approximately two seconds to approximately three seconds. The threshold value for the TTC ensures that the air dam 22 has sufficient time to actuate into the non-deployed position before the external object 50 located in front of the vehicle 10 could impact the air dam 22. That is, the threshold value for the TTC depends on the amount of time that the air dam 22 requires to actuate from the deployed position into the non-deployed position. In one embodiment, the air dam 22 is able to actuate into the deployed position in approximately two seconds to approximately three seconds at an ambient temperature of about 25° C., however it is understood that this amount of time may vary depending on the different types of air dams that are used.

The actuation of the air dam 22 depends on the speed of the vehicle 10. For example, in one embodiment the control module 32 includes logic for sending a control signal to the air dam actuation mechanism 24 for actuating the air dam 22 from the non-deployed position into the deployed position if the speed of the vehicle 10 is greater than or equal to a predetermined speed S1 for a period of time T1. In one embodiment, the time T1 is about three seconds, and the predetermined speed S1 is about 56 kph (35 mph). The control module 32 may also include logic for actuating the air dam 22 from the deployed position into the non-deployed position if the speed of the vehicle 10 is greater than or equal to a predetermined speed S2, for a period of time T2. In one embodiment, the predetermined speed S2 is about 240 kph (150 mph) and the time T2 is about three seconds. The control module 32 may also include logic for actuating the air dam 22 from the non-deployed position into the deployed position if the speed of the vehicle 10 is less than a predetermined speed S3 for a period of time T3. In one embodiment, the predetermined speed S3 is about 240 kph (150 mph), and the time T3 is about three seconds. Finally, the control module 32 may include logic for actuating the air dam 22 from the deployed position into the non-deployed position if the speed of the vehicle 10 is less a predetermined speed S4 for a period of time T4. In one embodiment, the predetermined speed S4 is about 56 kph (35 mph), and the time T4 is about three seconds.

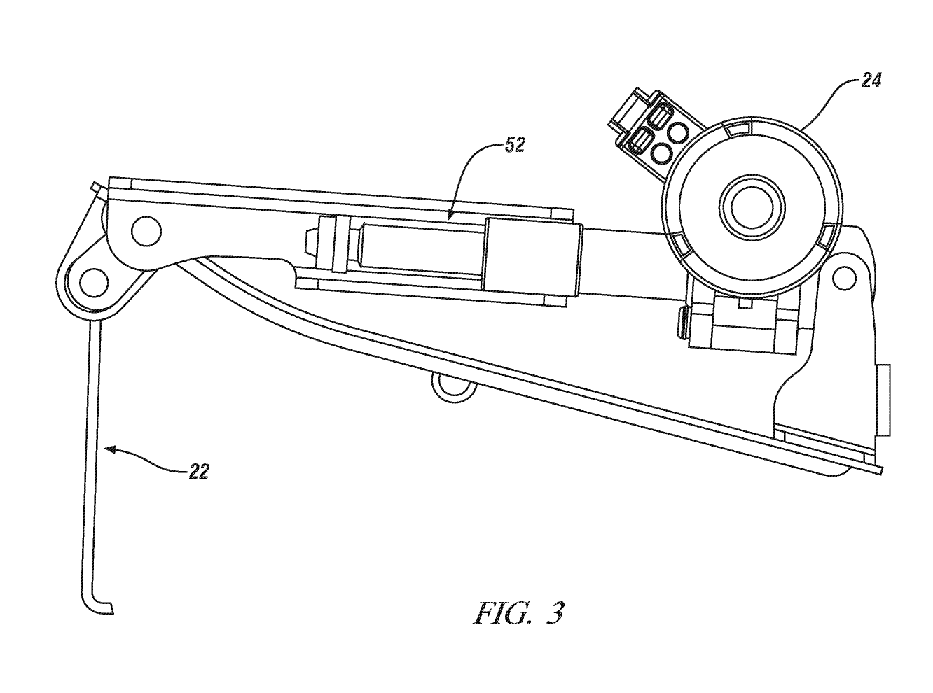

If the object sensor 30 is employed by both of the air dam actuation system 20 as well as the ACC system 34 or a CMB system, then the air dam actuation system 20 does not require a dedicated object sensor. Sharing the object sensor 30 reduces the cost and complexity of the vehicle 10. FIG. 3 is an exemplary embodiment of the air dam 22, the air dam actuation mechanism 24, and a linkage system 52 that is connected to both the air dam 22 and the air dam actuation mechanism 24. In the embodiment as shown, the air dam actuation mechanism 24 is a motor. FIG. 3 illustrates the air dam 22 in the deployed position, where the air dam 22 is lowered to re-direct air flow to enhance vehicle control and engine cooling. The linkage system 52 receives input from the air dam actuation mechanism 24 to actuate the air dam 22 between the deployed and non-deployed positions. In one embodiment, the linkage system 52 includes a worm-screw driven linkage, however it is understood that other approaches may be used as well to actuate the air dam 22.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system for air dam actuation of a vehicle, comprising:
an object sensor for tracking external objects located in front of the vehicle;
an air dam having a deployed position and a non-deployed position;
an actuation mechanism connected to the air dam, the actuation mechanism actuating the air dam between the deployed and the non-deployed position; and
a control module in communication with the object sensor and the actuation mechanism, the control module having:
a logic for monitoring the object sensor for a set of object data, wherein the set of object data is data indicating if an external object is located in front of the vehicle;
a logic for determining if the set of object data indicates that the external object located in front of the vehicle has the potential to impact the air dam;
a logic for determining a time to collision (“TTC”) between the air dam and the external object located in front of the vehicle if the external object has the potential to impact the air dam, wherein the TTC is based on at least on a vehicle speed and the set of object data; and
a logic for sending an air dam data signal to the actuating mechanism for actuating the air dam from the deployed position into the non-deployed position if the TTC is below a threshold time value.

2. The system of claim 1, wherein the object sensor is part of one of an adaptive cruise control (“ACC”) system and a collision mitigation braking (“CMB”) system.

3. The system of claim 1, wherein the control module includes logic for sending a control signal to the air dam actuation mechanism for actuating the air dam from the non-deployed position into the deployed position if the speed of the vehicle is one of greater than and equal to a specified speed for a specified period of time.

4. The system of claim 3, wherein the specified speed is about 56 kph and the specified period of time is about three seconds.

5. The system of claim 3, wherein the specified speed is about 240 kph and the specified period of time is about three seconds.

6. The system of claim 1, wherein the control module includes logic for monitoring the object sensor for a second set of object data, wherein the second set of object indicates if an external object is located in front of the vehicle and has the potential to activate a reduction in the vehicle speed.

7. The system of claim 1, wherein the control module includes logic for monitoring the object sensor for a second set of object data, wherein the second set of object data indicates if an external object is located in front of the vehicle and has the potential to activate a braking system of the vehicle.

8. The system of claim 1, wherein the object sensor is one of a long range radar, short range radar, a camera, and a light detection and ranging (“LIDAR”) optical remote sensing technology

9. The system of claim 1, wherein the threshold time value for the TTC ranges from between approximately two seconds to approximately three seconds.

10. The system of claim 1, wherein the TTC is based on an amount of time needed to actuate the air dam from the deployed position to the non-deployed position.

11. A system for air dam actuation of a vehicle, comprising:
an object sensor for tracking external objects located in front of the vehicle, the object sensor part of one of an adaptive cruise control (“ACC”) system and a collision mitigation braking (“CMB”) of the vehicle;
an air dam having a deployed position and a non-deployed position;
an actuation mechanism connected to the air dam, the actuation mechanism actuating the air dam between the deployed and the non-deployed position; and
a control module in communication with the object sensor and the actuation mechanism, the control module having:
a logic for monitoring the object sensor for a set of object data, wherein the set of object data is data indicating if an external object is located in front of the vehicle;
a logic for determining if the set of object data indicates that the external object located in front of the vehicle has the potential to impact the air dam;
a logic for determining a time to collision (“TTC”) between the air dam and the external object located in front of the vehicle if the external object has the potential to impact the air dam, wherein the TTC is based on at least on a vehicle speed and the set of object data; and
a logic for sending an air dam data signal to the actuating mechanism for actuating the air dam from the deployed position into the non-deployed position if the TTC is below a threshold time value.

12. The system of claim 11, wherein the control module includes logic for sending a control signal to the air dam actuation mechanism for actuating the air dam from the non-deployed position into the deployed position if the speed of the vehicle is one of greater than and equal to a specified speed for a specified period of time.

13. The system of claim 12, wherein the specified speed is about 56 kph and the specified period of time is about three seconds.

14. The system of claim 12, wherein the specified speed is about 240 kph and the specified period of time is about three seconds.

15. The system of claim 11, wherein the control module includes logic for monitoring the object sensor for a second set of object data, wherein the second set of object indicates if an external object is located in front of the vehicle and has the potential to activate reduction in the vehicle speed.

16. The system of claim 11, wherein the control module includes logic for monitoring the object sensor for a second set of object data, wherein the second set of object data indicates if an external object is located in front of the vehicle and has the potential to activate a braking system of the vehicle.

17. The system of claim 11, wherein the threshold time value for the TTC ranges from between approximately two seconds to approximately three seconds.

18. The system of claim 11, wherein the TTC is based on an amount of time needed to actuate the air dam from the deployed position to the non-deployed position.

19. A system for air dam actuation of a vehicle, comprising:
an object sensor for tracking external objects located in front of the vehicle, the object sensor part of an adaptive cruise control (“ACC”) system of the vehicle for adjusting a vehicle speed;
an air dam having a deployed position and a non-deployed position;
an actuation mechanism connected to the air dam, the actuation mechanism actuating the air dam between the deployed and the non-deployed position; and
a control module in communication with the object sensor and the actuation mechanism, the control module having:
a logic for monitoring the object sensor for a first set of object data, wherein the set of object data is data indicating if an external object is located in front of the vehicle;
a logic for monitoring the object sensor for a second set of object data, wherein the second set of object data is data indicating if an external object is located in front of the vehicle and has the potential to activate reduction in the vehicle speed;
a logic for determining if the first set of object data indicates that the external object located in front of the vehicle has the potential to impact the air dam;
a logic for determining a time to collision (“TTC”) between the air dam and the external object located in front of the vehicle if the external object has the potential to impact the air dam, wherein the TTC is based on at least on the vehicle speed, the first set of object data, and an amount of time needed to actuate the air dam from the deployed position to the non-deployed position; and
a logic for sending an air dam data signal to the actuating mechanism for actuating the air dam from the deployed position into the non-deployed position if the TTC is below a threshold time value.

20. The system of claim 19, wherein the object sensor is one of a long range radar, short range radar, a camera, and a light detection and ranging (“LIDAR”) optical remote sensing technology
